(19) United States
(12) Patent Application Publication
(10) Pub. No.: US 2003/0108307 A1
(43) Pub. Date: Jun. 12, 2003

(54) Optical attenuator employing a fusion splice

(75) Inventors: Lars Erik Eskildsen, Holmdel, NJ (US); Torben N. Nielsen, Monmouth Beach, NJ (US)

Correspondence Address: MAYER, FORTKORT & WILLIAMS, PC, 251 NORTH AVENUE WEST, 2ND FLOOR, WESTFIELD, NJ, 07090, US

(73) Assignee: Photuris, Inc.

(21) Appl. No.: 10/008,370

(22) Filed: Dec. 6, 2001

(51) Int. Cl. G02B 6/255; G02B 6/26

(52) U.S. Cl. 385/96; 385/140

(57) ABSTRACT

An optical attenuator and a method of making an optical attenuator is disclosed. The method begins by arranging a first end of a first optical fiber and a second end of a second optical fiber so that they face one another in close proximity. The first and second ends of the optical fibers are then laterally offset from one another and the first end of the first fiber is fused to the second end of the second fiber to create a fusion splice. Next, the attenuation imposed on an optical signal transmitted from the first to the second optical fiber and through the fusion splice is measured to determine an initial deviation in attenuation from a prescribed value. The fusion splice is then re-fused while exerting an axially directed force on the first and second ends of the optical fiber. The measurement step is repeated to determine a subsequent deviation in attenuation from the prescribed value and the re-fusion step is repeated to reduce the subsequent deviation in attenuation. If necessary, this process is repeated until a resulting deviation in attenuation falls within a prescribed tolerance.

### FIELD OF THE INVENTION

The present invention relates generally to optical fibers used in optical transmission systems, and more particularly to a fusion splice optical attenuator used in optical transmission systems.

### BACKGROUND OF THE INVENTION

As dense wavelength division multiplexed (DWDM) optical transmission systems become more and more complex the need for controlling the power levels becomes increasingly important. This issue can be addressed by providing an optical attenuator at any of a variety of places in such a system. For example, the process of maintaining sufficient optical transmission quality can be improved by precisely controlling the optical power levels of the output power from the transmitter lasers, ensuring that large variations in the launch power due to manufacturing variations are eliminated. In this way all transmitter lasers can be brought to the desired output power level.

Some conventional optical attenuators employ separate piece-parts that are inserted between the ends of two optical fibers by means of a mechanical coupling device. Other optical attenuators eliminate the separate piece-parts by using the attenuation that arises in a fusion splice that is formed when two optical fibers are connected to one another. In a fusion splice a fiber positioner aligns the fiber ends from two fibers until optimum fiber-to-fiber transmission is achieved. A current is then supplied to two electrodes, with the resulting electric arc heating the optical fibers such that the two abutting ends are fused together. The heat needed to form the fusion splice may be achieved by means other than an electric discharge, such as laser heating or flame heating. However, electric discharge is most commonly employed and is discussed, for example, in D. L. Bisbee, “Splicing Silica Fibers with an Electric Arc, Applied Optics, Vol. 15, No. 3, March 1976, pp. 796-798.

A conventional fusion splice optical attenuator has been achieved by offsetting the fibers ends so that they are misaligned prior to forming the fusion splice. The degree of misalignment, which is adjusted by visually observing the fiber ends, is selected to induce the desired optical loss after fusion splicing is performed. Unfortunately, the accuracy of this technique is limited and may not be adequate for controlling power levels in more complex optical transmission systems. For example, with an attenuator that is to provide 5 dB of loss, the precision that can be achieved may be only +/−1 dB.

Accordingly, there is a need to provide a fusion splice optical attenuator that has an attenuation which can be more precisely tailored than has heretofore been achievable.

### SUMMARY OF THE INVENTION

In accordance with the present invention, an optical attenuator and a method of making an optical attenuator is disclosed. The method begins by arranging a first end of a first optical fiber and a second end of a second optical fiber so that they face one another in close proximity. The first and second ends of the optical fibers are then laterally offset from one another and the first end of the first fiber is fused to the second end of the second fiber to create a fusion splice. Next, the attenuation imposed on an optical signal transmitted from the first to the second optical fiber and through the fusion splice is measured to determine an initial deviation in attenuation from a prescribed value. The fusion splice is then re-fused while exerting an axially directed force on the first and second ends of the optical fiber. The measurement step is repeated to determine a subsequent deviation in attenuation from the prescribed value and the re-fusion step is repeated to reduce the subsequent deviation in attenuation. If necessary, this process is repeated until a resulting deviation in attenuation falls within a prescribed tolerance.

In accordance with one aspect of the invention, if the initial deviation results in an attenuation that is less than the prescribed value, the axially directed force is arranged to compress the first and second ends of the fibers. Alternatively, if the initial deviation results in an attenuation that is greater than the prescribed value, the axially directed force is arranged to pull the first and second ends of the fibers apart from one another.

### BRIEF DESCRIPTION OF THE DRAWINGS

FIG. 1 shows the functional elements of a conventional fusion splicer.

FIG. 2 shows the attenuation achieved at intermediate steps during the process of making 4.00 dB attenuators in accordance with the present invention.

FIG. 3 is a table summarizing data for eleven different attenuators that were fabricated in accordance with the present invention.

### DETAILED DESCRIPTION

The present invention provides an optical attenuator using a fusion splice whose attenuation can be more precisely controlled than in the aforementioned conventional fusion splice optical attenuators. In particular, a conventional fusion splice is re-fused while the fiber ends are manipulated in a manner that will be described below. However, in order to facilitate a better understanding of the present invention, a brief discussion will now be provided of fusion splicers and the process of forming a fusion splice.

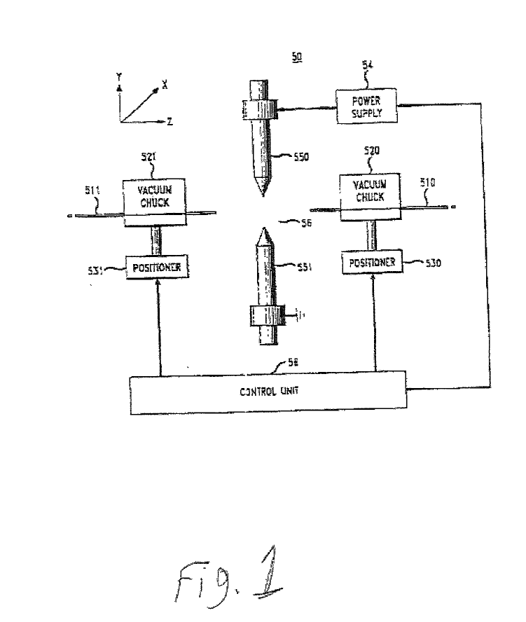

FIG. 1 schematically depicts the functional elements of a conventional fusion splicer. Fusion splicer 50 comprises fiber holding means 520 and 521 (e.g., known vacuum chucks or mechanical means such as spring loaded or magnetic clamps), fiber aligning means 530 and 531 (e.g., comprising known servo-controlled micro-positioning means), and means for maintaining an arc (comprising an appropriate power supply 54) between electrodes 550 and 551. FIG. 1 also shows optical fibers 510 and 511, control unit 54, and arc 56. Exemplarily, the Z-direction is parallel to the fiber axis, the X-Z plane is the “horizontal” plane, and the Y direction is normal to the X-Z plane, positioning means 530 can adjust the position of the fiber 510 in the Y and Z directions, and positioning means 531 can adjust the position of fiber 511 in the X and Z directions. Those skilled in the art will appreciate that FIG. 1 is a schematic illustration of functional elements, and that various necessary, but conventional, parts are not shown. For instance, all the parts shown in FIG. 1 are typically integrated into a single unit, requiring provision of mounting means and housing means.

A typical fusion splice is formed with fusion splicer 50 in the following manner. After conventional preparatory steps such as coating stripping, fiber cleaning and cleaving, the fibers are mounted in the apparatus, and positioned such that the ends are almost in contact with one another and optically aligned in the X and Y directions. The fiber alignment performed by fiber aligning means 530 and 531 may be achieved by active alignment, in which the fibers are moved laterally to obtain accurate positions before discharge. Active alignment may employ power monitoring methods. Power monitoring may be accomplished automatically by transmitting optical power through the fibers and detecting the power after traversing the fusion splice, in which case the detected power may be used as a feedback signal to adjust the lateral position of the fibers. Alternatively, power monitoring may be accomplished visually with a microscope. Once the fibers are aligned they are moved in the z-direction to decrease the gap between them while an electric discharge is generated across electrodes 550 and 551, which discharge is maintained for a predetermined period. The electric discharge melts the fibers so that they fuse together while in the plastic state. Fusion splicer 50 may automatically perform the entire aforementioned process. Following the formation of the fusion splice, conventional steps such as annealing and re-coating of the splice region may be performed.

As previously mentioned, a fusion splice has been used as an optical attenuator. Such an attenuator has been formed by offsetting the fiber ends to induce the desired loss. Because the degree of misalignment between the fiber ends is determined by visual observation, the accuracy that can be achieved is limited, in turn limiting the precision in the value of attenuation that can be achieved.

In accordance with the present invention, an optical attenuator formed in the aforementioned manner undergoes post-processing to increase its precision. In particular, the inventors has surprisingly determined that the value of the attenuation imparted by such an optical attenuator can be finely adjusted by re-fusing the fusion splice while pushing or pulling the fiber ends toward or away from one another. For instance, if the attenuation of the attenuator is below the desired value, the fusion splice can be re-fused while pushing the fiber ends together. This has the effect of increasing the loss in the fusion splice. Alternatively, if the attenuation of the attenuator is above the desired value, the fusion splice can be re-fused while pulling the fiber ends apart. This has the effect of reducing the loss in the fusion splice. The re-fusion step may be repeated as many times as needed until the desired attenuation is achieved. This procedure is reversible in the sense that after repeatedly performing the re-fusion step while pushing (or pulling) on the fiber ends the change in attenuation can be reversed by performing one or more re-fusion steps while pulling (or pushing) on the fiber ends.

### EXAMPLE

A series of fusion splice optical attenuators were fabricated as follows. After performing the conventional preparatory steps of coating stripping, fiber cleaning and cleaving, two optical fibers were mounted in a conventional, automatic, electric discharge fusion splicer, available from Ericsson as model number FSU 995. The cores of the fibers were deliberately offset from one another by a small amount and the fusion splicer created a fusion splice. Next, the attenuation imparted by the fusion splice was measured by connecting a light source to one end of the spliced fiber and a detector to the other end of the spliced fiber. If the attenuation was below its target value, the two ends of the fibers were compressed while a brief electric discharge was established to re-fuse the splice (It should be noted that while in this example the duration and intensity of the subsequent discharge was the same as for the initial splice, more generally the parameters for the re-fusion process can be selected independently of the initial fusion parameters.) If the attenuation was above its target value, the two ends of the fibers were pulled apart while the brief electric discharge was established. The attenuation was again measured and the re-fusing step repeated until the resulting attenuation deviated from the target value by less than a specified amount.

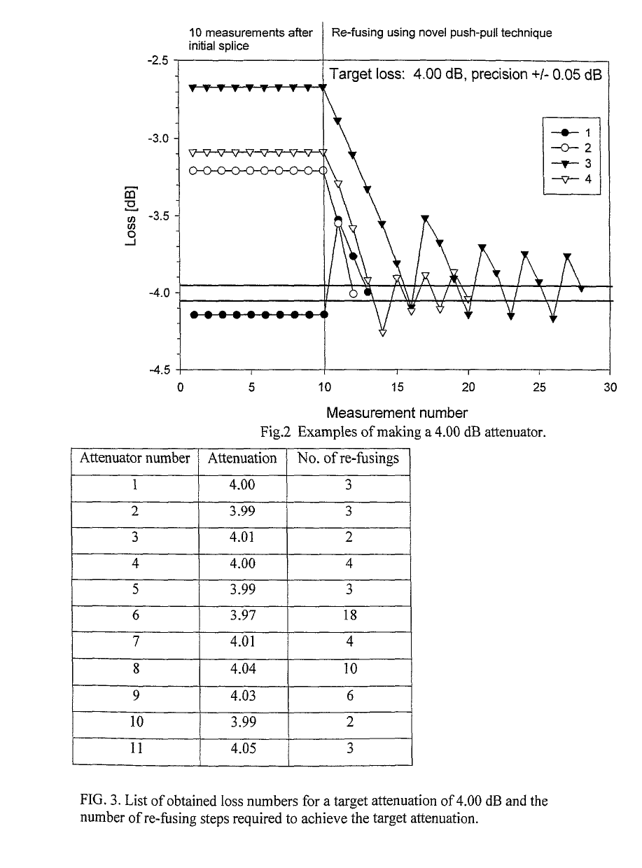

FIG. 2 shows the loss achieved during the process of making a 4.00 dB attenuator. The first 10 measurements were obtained after the initial fusion and before any re-fusing to determine the initial induced attenuation. Each measurement number thereafter represents one re-fusing step while either pushing or pulling on the fibers as described above. The two horizontal lines centered about a loss of 4.00 dB indicate the target precision of ±0.05 dB that is to be achieved. The four curves each represents the process for a different attenuator.

Curve 1 illustrates an attenuator in which its initial attenuation was too large. Consequently the fibers were subsequently pulled apart during re-fusion, which resulted in too small an attenuation (measurement no. 11), then pushed together (measurements nos. 12 and 13), which increased the loss to within the target value of ±0.05 dB. The re-fusion process was stopped after measurement no. 13.

Curve 2 shows an attenuator in which the initial loss was too small and subsequent re-fusing steps were performed while pushing the fibers together, resulting in the desired attenuation of 4.00 dB.

Curves 3 and 4 illustrate additional examples in which a few iterations were needed to adjust the attenuation to within the target range.

FIG. 3 is a table listing 11 different attenuators that were formed in accordance with the present invention. The table shows the final attenuation that was achieved as well as the number of re-fusing steps that were necessary to achieve the required precision.

Additional fusion splice optical attenuators fabricated in accordance with this example imparted optical attenuation ranging between 0.1 dB and 15 dB with a precision of +/−0.05 dB. This degree of precision is believed to be sufficient for most current applications. While the precision could have been increased even further, the number of times the re-fusion step would have needed to be repeated would have increased substantially. Nevertheless, a precision of +/−0.05 dB is about two orders of magnitude better than can be typically achieved by the conventional process of fabricating a fusion splice optical attenuator, which was discussed earlier.

Although various embodiments are specifically illustrated and described herein, it will be appreciated that modifications and variations of the present invention are covered by the above teachings and are within the purview of the appended claims without departing from the spirit and intended scope of the invention. For example, while the present invention has been described in terms of a fusion splice formed by electric discharge, the fusion splice may be formed in any conventional manner, including laser or flame heating, and with a fusion splicer that operates automatically or manually. Moreover, the present invention is applicable to both single mode and multi-mode optical fibers and to ribbon fibers that undergo mass fusion splicing.

What is claimed is:

1. A method of fabricating an optical attenuator comprising the steps of:
a. arranging a first end of a first optical fiber and a second end of a second optical fiber so that they face one another in close proximity;
b. laterally offsetting from one another the first and second ends of the optical fibers;
c. fusing the first end of the first fiber to the second end of the second fiber to create a fusion splice;
d. measuring attenuation imposed on an optical signal transmitted from the first to the second optical fiber and through the fusion splice to determine an initial deviation in attenuation from a prescribed value;
e. re-fusing the fusion splice while exerting an axially directed force on the first and second ends of the optical fiber;
f. repeating step (d) to determine a subsequent deviation in attenuation from the prescribed value;
g. repeating step (e) to reduce the subsequent deviation in attenuation;
h. if necessary, repeating steps (f) and (g) until a resulting deviation in attenuation falls within a prescribed tolerance.

2. The method of claim 1 wherein the initial deviation results in an attenuation that is less than the prescribed value and the axially directed force compresses the first and second ends of the fibers.

3. The method of claim 1 wherein the initial deviation results in an attenuation that is greater than the prescribed value and the axially directed force pulls the first and second ends of the fibers apart from one another.

4. The method of claim 1 wherein the prescribed tolerance is less than or equal to +/−0.05 dB.

5. The method of claim 1 wherein the step of creating a fusion splice is performed by an electric discharge fusion splicer.

6. The method of claim 1 wherein the first and second optical fibers are single mode fibers.

7. The method of claim 1 wherein the first and second optical fibers are multimode fibers.

8. A fusion splice optical attenuator formed in accordance with the method of claim 1.

9. A fusion splice optical attenuator formed in accordance with the method of claim 6.
